(19) United States
(12) Patent Application Publication
(10) Pub. No.: US 2007/0147675 A1
(43) Pub. Date: Jun. 28, 2007

(54) Image detection system, comprising an X-ray sensor and an image detecting unit, and method of operating same

(76) Inventors: Johannes Ulrici, Heidelberg (DE); Ulrich Schulze-Ganzlin, Lorsch (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/634,382

(22) Filed: Dec. 6, 2006

Related U.S. Application Data
(60) Provisional application No. 60/742,544, filed on Dec. 6, 2005.

(51) Int. Cl. G06K 9/00

(52) U.S. Cl. 382/132

(57) ABSTRACT

The invention relates to an image detection system, comprising an X-ray sensor 1 and an image detecting unit 5 which is connected to said sensor 1 via a cable 6 and which reads out data produced in the sensor and also exhibits a computer interface 5.1 to a computer 7 or a computer network. The image detecting unit is external of said computer 7 and designed to be independent of X-ray control means 4 and has at least one actuating element 9 and/or at least one display unit 10. Also disclosed are methods of operating said image detection system.

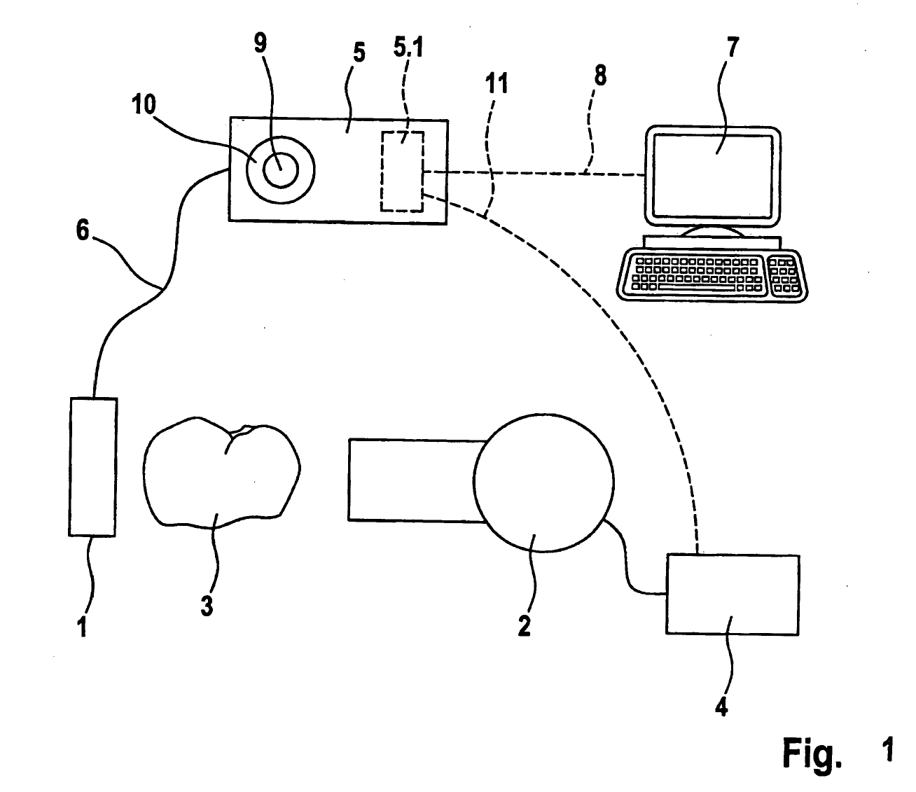

### TECHNICAL FIELD

The invention relates to an image detection system comprising an X-ray sensor and an image detecting unit, which unit is connected to the sensor via a cable, adapted, in particular, for the production of digital dental images, and to a method of operating the image detection system.

### DESCRIPTION OF THE RELATED ART

A radiation detector having a housing for the accommodation of a: radiation transformer is disclosed in DE 44 02 114 A1, in which radiation, especially X-ray radiation, impinging thereon is converted to electric signals. The radiation detector is of a cordless design and is provided with means for inputting energy and outputting signals.

A mobile device for detecting and transmitting data for use in dentistry is disclosed in DE 196 01 718. The mobile device comprises actuating elements and display units. The mobile device can be connected to an X-ray device for the production of intraoral X-ray images, and serves to control and display incoming and outgoing data. The acquisition of the X-ray image can be triggered from the mobile device.

An X-ray sensor used for producing intraoral images is disclosed in WO 02 41 783 A1. The sensor is connected via a cable to a computer and is controlled via the computer. This suffers from the drawback that it is necessary to keep a constant eye on the display unit of the computer in order to control the sensor.

An image detector for the creation of digital dental images is disclosed in DE 103 13 976 A1, which detector comprises display means for indicating the status of the image detector, on which an actuating element is provided.

### SUMMARY AND OBJECTS OF THE INVENTION

The image detection system of the invention comprises an X-ray sensor for measuring X-rays and an image detecting unit connected to the sensor via a cable, which unit reads out data generated in the sensor and has an interface with a computer or computer network. The interface may be, for example, a USB interface or an ethernet interface. A computer is understood to be a PC, laptop, or other data processing unit. The image detecting unit is disposed externally of the computer and is designed to be independent of any X-ray control means and comprises at least one actuating element and/or at least one (preferably) optical indicator.

The image detecting unit contains all electronic components necessary for outputting image signals from the sensor. Digitization of the analog signals generated in the sensor by the X-rays may also take place in the image detecting unit in the event that such digitization has not already taken place in the sensor, as the latter is likewise possible. The current and voltage supply to the sensor may be provided via the computer interface, or it can be provided in the image detecting unit itself.

The image detecting unit is advantageously designed as a fully independent unit. The advantage therein is that it is possible to acquire image signals from the sensor in the event that connections to other devices have been broken. The image detecting unit together with the sensor attached thereto forms an independent and mobile unit, which has the further advantage that there are no additional connections that would impede freedom of mobility.

At least one indicating unit is advantageously controlled by means of a computer. It is thereby possible to provide the operator with information from the computer. This may be information concerning, for example, whether an image relating to a patient or a random image, i.e., one not directly assigned to a patient, is being produced.

If, for example, the indicator light is continuously on, no special attention is required from the operator and an image is automatically assigned to a patient. A blinking indicator light, however, will mean that the image has not yet been assigned to a patient and that it must be assigned to a patient after it has been created.

At least one indicator is advantageously controlled via the sensor. It is thus possible to provide the operator with information from the sensor. This may be, for example, information as to whether the sensor itself is in proper working condition.

If, for example, the indicator light is on continuously, no special attention is required from the operator and the sensor is in proper working order. A blinking indicator light, however, will mean that the sensor is not functioning properly and that it must be reset or replaced.

Advantageously, at least one indicator indicates the status of the sensor, in particular its image detection readiness. It is possible thereby to provide the operator with information from the sensor. This may be, for example, information as to whether the sensor is ready for image detection in cooperation with the computer.

If, for example, the indicator light is on continuously, no special attention is required from the operator and the sensor and the computer are ready for image detection, i.e., an image can be produced and stored in the computer. A blinking indicator light, however, will mean that the devices are not ready for image detection.

The actuating element is advantageously so designed that actuation thereof will lead to a change of status of the computer and/or sensor. This makes it possible to change the status of the computer or the sensor from a certain distance remote from the computer or after the sensor has already been placed in the oral cavity, without having to act directly on the computer or the sensor itself. For example, it is possible, by actuating said element, to cause the sensor and computer to switch over to the status of image detection readiness.

The actuating element is advantageously a switch or key which is at least partially surrounded by the indicator, which is preferably in the form of an illuminable ring or section of a ring. The illumination can be variable both as to color and as to mode of operation, e.g., continuously on, blinking rapidly, blinking slowly.

The image detecting unit is advantageously located near to the object to be imaged. In this way it will be unlikely that the system will be used when it is not ready for detection, since the indicator on the image detecting unit is located within the operator's field of vision when the operator's vision is focused on the object to be detected. The patient is thus protected from erroneous X-ray irradiation.

An additional object of the invention is a method for the production of an intraoral X-ray image, wherein in a first step following the actuation of a control element disposed on the image detecting unit, a signal is transmitted to a computer connected to the image detecting unit via an interface, which unit is connected to an X-ray sensor via a cable. In a second step, the image detection readiness of the sensor on the one hand, and that of the computer and its associated software on the other hand, is queried by the computer and, if necessary, an attempt is made to establish the operating status relevant to the signal. In a third step, the attainment of the operating status is indicated by indicator means located on the image detecting unit.

This has the advantage that the image detecting unit is not essentially required to have its own control means in order to function, because all essential functions are monitored by the computer.

As an alternative to the aforementioned, and according to an additional object of the invention, a method for the production of an intraoral X-ray image is proposed, wherein, in a first step following the actuation of an actuating element mounted on the image detecting unit, a signal is transmitted, on the one hand, to the sensor and, on the other hand, to a computer connected via an interface to the image detecting unit, which unit is connected to an X-ray sensor via a cable. In a second step, the readiness of the sensor, on the one hand, and of the computer and its associated software, on the other hand, for image detection is determined with reference to the evaluation of the response signal received from the sensor and the computer, and if necessary, an attempt is made to achieve the operating status relevant to the signal. In a third step, the attainment of the operating status is indicated via an indicator located on the image detecting unit.

The implementation of the method presupposes that the image detecting unit has control means, and the advantage thus gained is that the image detecting unit independently monitors all of the functions of the sensor and of the computer.

According to an advantageous development, it is possible to make a selection between a patient-related image and a random image and preset an indicator disposed on an image detecting unit externally of the computer to an operating status relevant to this selection.

The advantage of this method is that the operator can consult the indicator to confirm the preset status of the system regarding the assignment of the image to a selected patient.

According to an additional advantageous development, the sensor can only be set to an image detection readiness mode by the selection of either a random image or a patient-related image on a computer. An unnecessary X-ray irradiation is thus avoided if, for example, a random image is mistakenly selected in lieu of an intended patient-related image.

### BRIEF DESCRIPTION OF THE DRAWINGS

The method of the invention is explained below with reference to the drawing.

The sole FIGURE shows a basic configuration for the production of X-ray images according to the invention.

### DETAILED DESCRIPTION OF AN EXEMPLARY EMBODIMENT OF THE INVENTION

The sole FIGURE shows an image detection system comprising an X-ray sensor 1 for measuring X-rays which are emitted from an X-ray emitter 2 and which penetrate, at least in part, an object to be imaged 3, in this case a tooth. The X-ray emitter 2 is controlled via control means 4.

The sensor 1 is connected via a cable 6 to an image detecting unit 5 and is designed as an independent unit. This means that the image detecting unit 5 is external of a computer 7 and independent of the control means 4 of the X-ray emitter 2 influenced by the computer 7. A prerequisite for the aforementioned is that the image detecting unit 5 has its own control means. This, however, is not necessary if the image detecting unit 5 is controlled by the computer 7.

A connection 8 is provided between the image detecting unit 5 and the computer 7, which connection is in the form of a cable or is a cordless connection employing, for example, radio signals. The image detecting unit 5 comprises an interface 5.1 for establishing the connection.

The image detecting unit 5 comprises an actuating element 9 in the form of a key or a switch and additionally an optical indicator 10 in the form of an annular lamp which is positioned around the actuating element 9.

Furthermore, the image detecting element 5 may comprise additional control means (not shown) with which it is possible to adjust sensor functions or to send commands to the computer 7 or the X-ray device control, in a manner similar to a remote control. The status of the system set by means of the controls may then be indicated with the aid of additional optical indicators (not shown).

It is an essential feature of the present invention that, when preparing for the creation of an X-ray image, the image detecting unit 5 be moved together with the sensor 1 connected thereto by the sensor cable 6, which is not the case with an image detecting unit integrated in the computer 7. The connection 8 between the image detecting unit 5 and the computer 7 may alternatively be in the form of a cordless connection.

Acoustic indicators, for example a beeping noise or a voice output, may alternatively be employed in lieu of an optical indicator. LEDs are particularly suitable for use as indicators.

It is then not absolutely necessary to store the data read out from the sensor 1 in the image detecting unit 5, if the connection 8 with the computer 7 is ensured in the form of, say, a radio link or a cable connection.

It is possible to dispense with a separate power supply if the image detecting unit 5 is connected to the computer by cable.

It is within the scope of the present invention for the indicator 10 to additionally display the overall status of the image detection system, if desired.

1. An image detection system, comprising an X-ray sensor (1) and an image detecting unit (5) connected to said sensor (1) via a cable (6), which image detecting unit reads out data produced in the sensor, and further comprising a computer interface (5.1) to a computer (7) or computer network, characterized in that said image detecting unit is external of said computer (7) and is independent of an X-ray control means (4) and has at least one actuating element (9) and/or at least one display unit (10).

2. An image detection system as defined in claim 1, characterized in that said image detecting unit (5) is in the form of an independent unit.

3. A system as defined in claim 1 or claim 2, characterized in that at least one display unit (10) is controlled by said computer (7).

4. A system as defined in any one of claims 1 to 3, characterized in that at least one display unit (10) is controlled by said sensor.

5. A system as defined in any one of claims 1 to 4, characterized in that at least one display unit (10) indicates a state of said sensor (1), particularly its readiness for image detection.

6. A system as defined in any one of claims 1 to 5, characterized in that said actuating element (9) is designed such that actuation thereof leads to an alteration of a state in the computer (7) and/or in the sensor (1).

7. A system as defined in any one of claims 1 to 6, characterized in that said actuating element (9) is a switch or key and that said display unit (10) at least partially surrounds the actuating element (9), preferably in the form of an illuminable ring or section of a ring.

8. A system as defined in any one of claims 1 to 7, characterized in that said image detecting unit (5) is disposed in the vicinity of an object (3) to be X-rayed.

9. A method of creating an intraoral X-ray image, characterized in that
in a first step following actuation of an actuating element (9) disposed on an image detecting unit (5) connected to an X-ray sensor (1) via a cable (6), a signal is transmitted to a computer (7) connected to said image detecting unit via a computer interface (5.1),
in a second step, said computer (7) queries the image detection readiness of the sensor (1), on the one hand, and that of the computer (7) and the associated software, on the other hand, and, if necessary, the attempt is made to establish the operating state relevant to said signal, and,
in a third step, the attainment of said operating state is indicated by means of an indicator (10) disposed on said image detecting unit (5).

10. A method for creating an intraoral X-ray image, characterized in that
in a first step following actuation of an actuating element (9) disposed on an image detecting unit (5) connected to an X-ray sensor (1) via a cable (6), a signal is transmitted to said sensor (1), on the one hand, and to a computer (7) connected to said image detecting unit via a computer interface (5.1), on the other hand,
in a second step, with reference to the evaluation of the response signal resulting from said sensor (1) and said computer (7), the image detection readiness of the sensor (1), on the one hand, and of the computer (7) and its associated software, on the other hand, is determined and, if necessary, the attempt is made to establish the operating state relevant to said signal, and,
in a third step, the attainment of said operating state is indicated by means of an indicator (10) disposed on said image detecting unit (5).

11. A method as defined in claim 9 or claim 10, characterized in that
a selection between a patient-related image and a random image is carried out on a computer,
said selection switches an indicator disposed on an image detecting unit disposed externally of said computer to a predefined operating state.

12. A method as defined in claim 11, characterized in that said sensor can be switched to a state of image detection readiness only when a random image or a patient-related image has been selected on a computer.
